(19) United States
(12) Patent Application Publication
(10) Pub. No.: US 2015/0336247 A1
(43) Pub. Date: Nov. 26, 2015

(54) TORQUE WRENCH ADAPTER

(71) Applicant: Pervasive Engineering, Mechanicsville, MD (US)

(72) Inventor: Shawn M. Elford, Mechanicsville, MD (US)

(21) Appl. No.: 14/570,079

(22) Filed: Dec. 15, 2014

Related U.S. Application Data
(60) Provisional application No. 62/001,202, filed on May 21, 2014.

(51) Int. Cl. B25B 23/142; B25B 23/00

(52) U.S. Cl. CPC B25B 23/142; B25B 23/0007

(57) ABSTRACT

A torque wrench adapter having a length that is one-half of the effective length of a torque wrench that the adapter is being connected thereto, The adapter comprises a yoke for receiving the input shaft of the gear reducer on an escalader, and an extension that has a receiver for receiving the torque wrench drive on the torque wrench.

### CROSS REFERENCE TO RELATED APPLICATIONS

The instant application claims priority to U.S. Provisional Application 62/001,202 filed May 21, 2014 entitled Torque Wrench Adapter, the contents of which are herein incorporated by reference in its entirety.

### FIELD OF THE INVENTION

The invention relates to adapters that are attached to torque wrenches. The inventive adapter corrects the errors in brake torque value when calculating brake torque based on following the standard operating procedures (SOP) within the WESTINGHOUSE Escalator Maintenance Manual for escalators and using standard modern torque wrenches.

### BACKGROUND OF THE INVENTION

Escalators require routine inspection and maintenance. A brake check is one of the inspection and maintenance items that a technician needs to perform. The brakes are checked by calculating the brake torque. Brake torque is the amount of torque that exists when a technician applies a pressure to a torque wrench having a torque wrench adapter that initiates shaft movement to a reducer input shaft. The technician is required to multiply the value read off the torque wrench by a multiplier to get the value of brake torque since the torque arm is longer due to the addition of the adapter.

The adapters that a technician is known to use are depicted FIGS. 2 and 3, these “old” adapters are the wrong length for modern torque wrenches.

Technician are required to follow the procedures set forth in the WESTINGHOUSE Escalator Maintenance Manual (“Manual,” hereinafter) and the procedures set forth in their Standard Operation Procedures (SOP) documentation. The Manual requires the technician to insert the prior art adapters onto the escalator gear reducer's input shaft, attach a 12″ torque wrench to the adapter, and apply increasing pressure on the torque wrench until movement is observe on the input shaft. Of note, modern torque wrenches used by technician are much longer. Once movement is observed, the Manual instructs the technician to take a reading of the value on the torque wrench's dial or display. Then, the Manual instructs the technician to multiply that value by a factor of 1.5. The calculated value equates to the brake torque.

Technicians that inspect and maintain WESTINGHOUSE escalators are issued the prior art torque adapters as shown in FIGS. 2 and 3. As mentioned above, these adapters are known to vary in length and are too short for the modern torque wrenches used by technicians. This shortness in adapter length causes inaccurate calculations in brake torque when using modern torque wrenches. An inaccurate calculated brake torque value can be the difference between having the actual brake torque within the margin of safety or in need of replacement

Given the variances in length of torque wrenches and the prior art torque wrench adapters used to facilitate the calculation of brake torque with the multiplier factor of 1.5, the inventor has determined that a solution to making sure that the value of brake torque calculated is the correct value of brake torque at the input shaft is to produce an adapter that is exactly half of the effective length of the torque wrench being used by the technician.

FIG. 1 depicts a common torque wrench with an adapter 250 attached thereto. The torque wrench 200 has an overall of length 21 inches, and a square drive 210, a dial indicator 220, and a handle 230. With such a configuration, the actual torque AT being applied to a fastener, for instance, will be greater than the reading DR shown on the dial indicator 220.

Thus, there is a need to have an adapter of appropriate length to permit technicians to follow the procedures outlined in the Manual and their SOP in order to properly use multiplier factor of 1.5 as set forth in the Manual to determine the actual brake torque value.

### SUMMARY OF THE INVENTION

A torque adapter that is one half of the effective length of a torque wrench that the adapter is being connected thereto.

### BRIEF DESCRIPTION OF THE DRAWINGS

FIG. 1 depicts a torque wrench with a torque wrench adapter attached thereto.

FIG. 2 depicts a prior art torque wrench adapter.

FIG. 3 depicts a prior art torque wrench having a safety mechanism.

FIG. 4 depicts an embodiment of the adapter in perspective.

FIG. 5 depicts another embodiment of the adapter in perspective.

FIG. 6 depicts the adapter in planar view.

FIG. 7 depicts the adapter in planar view with preferred dimensions.

FIG. 8 depicts the adapter in planar view with a safety mechanism.

FIG. 9 depicts the adapter in perspective with the safety mechanism.

### DETAILED DESCRIPTION

FIGS. 4 and 5 depict the torque wrench adapters of the present invention. FIG. 4 depicts the torque wrench adapter without a safety mechanism, while FIG. 5 depicts the torque wrench adapter with a safety mechanism.

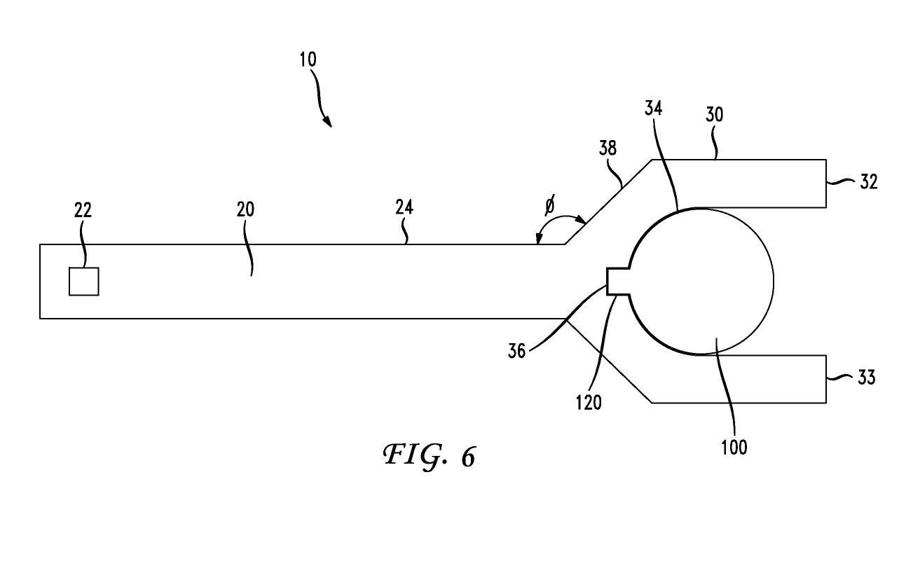

An embodiment of the torque wrench adapter is shown in FIG. 6. The torque wrench adapter 10 comprises an extension 20 and yoke 30. The extension 20 has a receiver 22 for receiving a torque wrench drive (not shown). The yoke 30 has two rigid jaws 32 and 33 that are connect by bight 34. As shown in the figures, the jaws 32 and 33 and bight 34 form a general U-shape. The inner surfaces of the jaws that contact input shaft 100 are preferably parallel. The bight 34 preferably follows the circumference of the input shaft 100 to a point where the bight 34 meets the jaws 32 and 33. At the vertex of bight 34 is a keyway 36. Keyway 36 is dimensioned to receive key 120 on input shaft 100 of the gear reducer on an escalader.

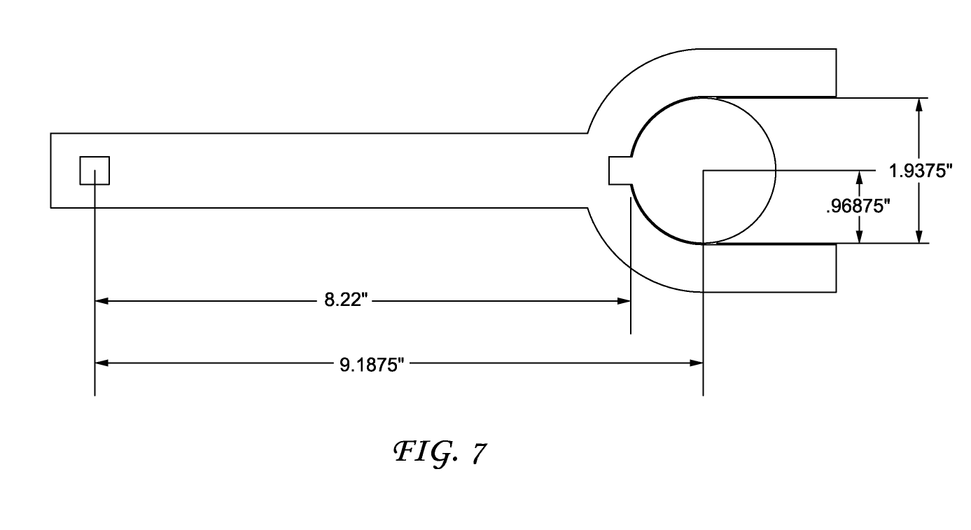

As shown in FIG. 6, an exterior edge 38 of the yoke 30 and an exterior edge 24 of the extension 20 intersect at angle θ. Angle θ can vary between 90 degrees to 170 degrees and is preferably between 120 degrees and 150 degrees. As an alternative, the yoke can be formed to resemble a Latin capital letter U in a sans serif font, see e.g., FIG. 7.

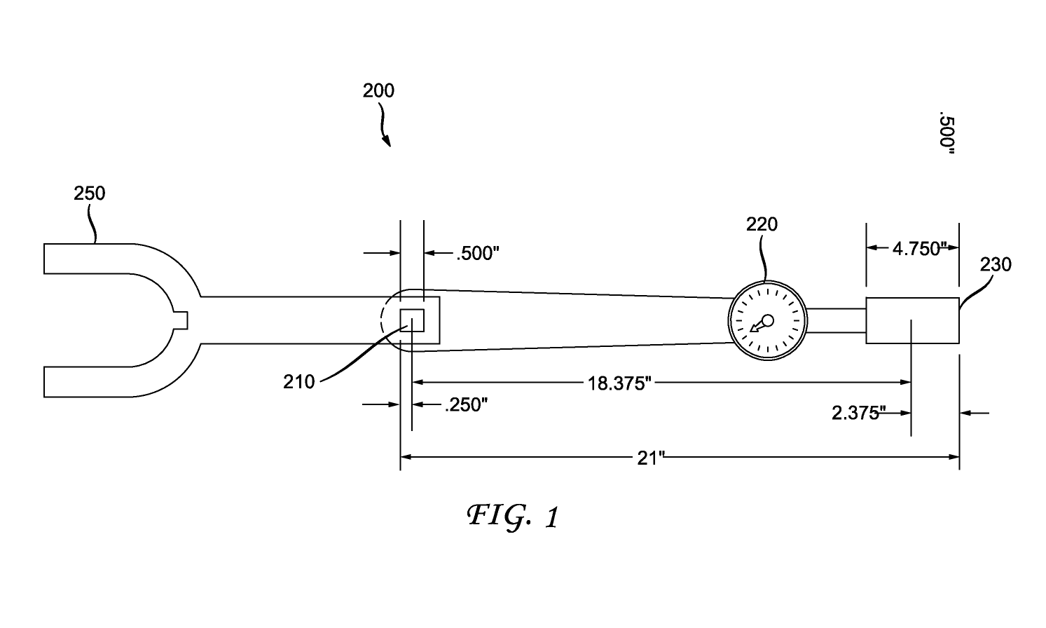

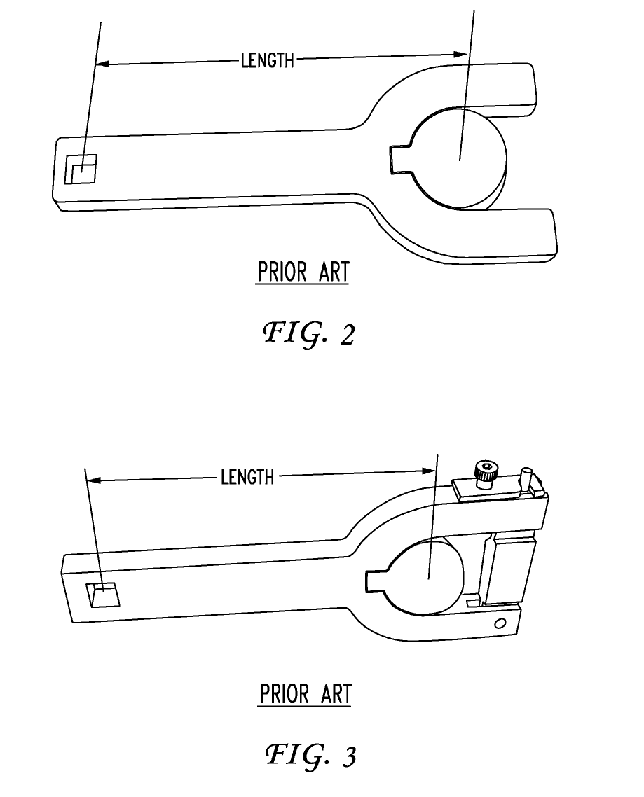

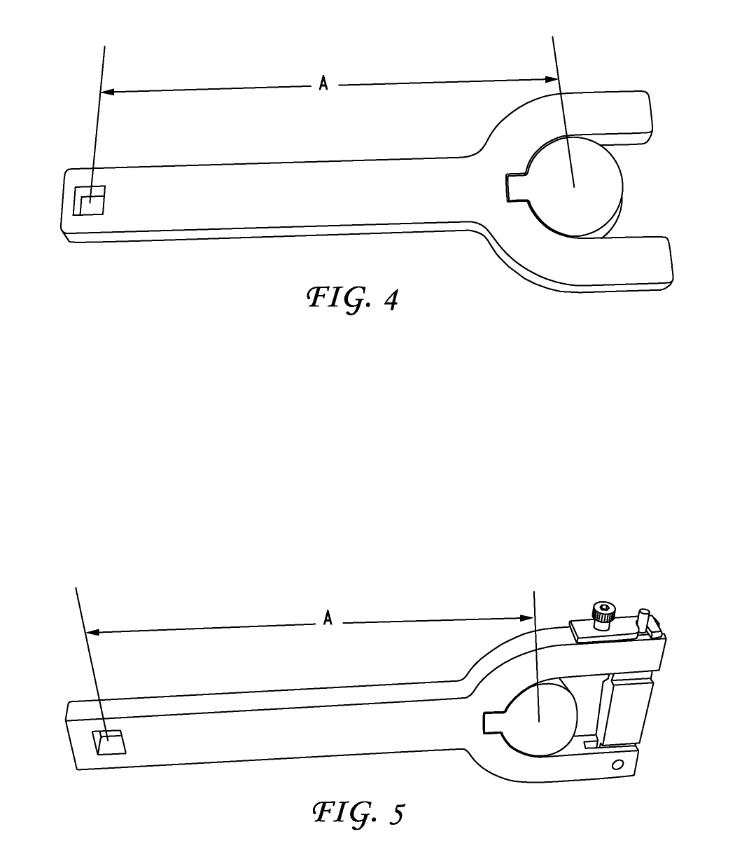

Given the length of the torque wrench depicted in FIG. 1 and the necessity to use the multiplier factor of 1.5, and knowing the diameter of the input shaft 100, the length A of the adapter 10 can be determined, The length A would be the length from the center point of the square drive receiver 22 to the center point of the input shaft that would be surrounded by the jaws 32 and 33 when the key was within the keyway 36. Given an input shaft 100 diameter of 1.9375 inches, the center point would be 0.96875 inches inwardly from the circumference of the inner shaft 100. Thus, the length A of adapter 22 would be 9.1875 inches which is one-half of the effective torque wrench length of 18.375 inches. See FIGS. 7 and 1.

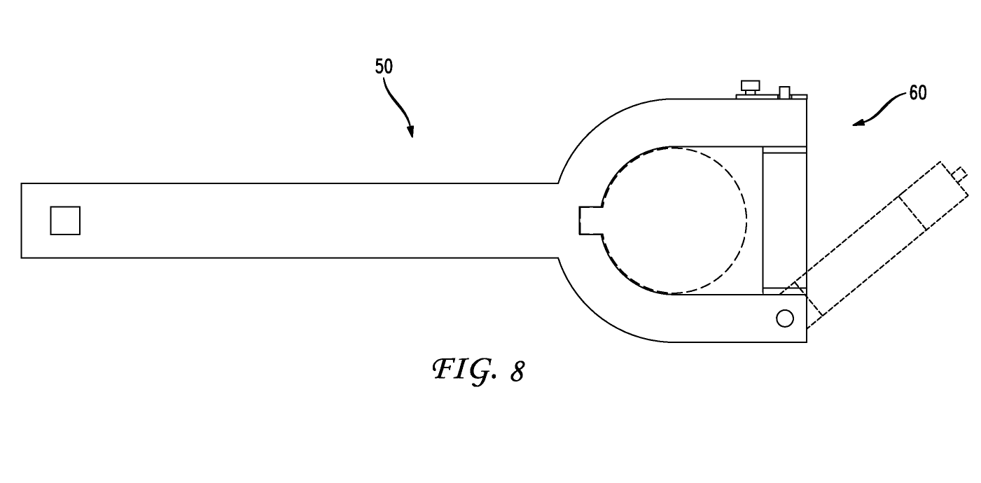

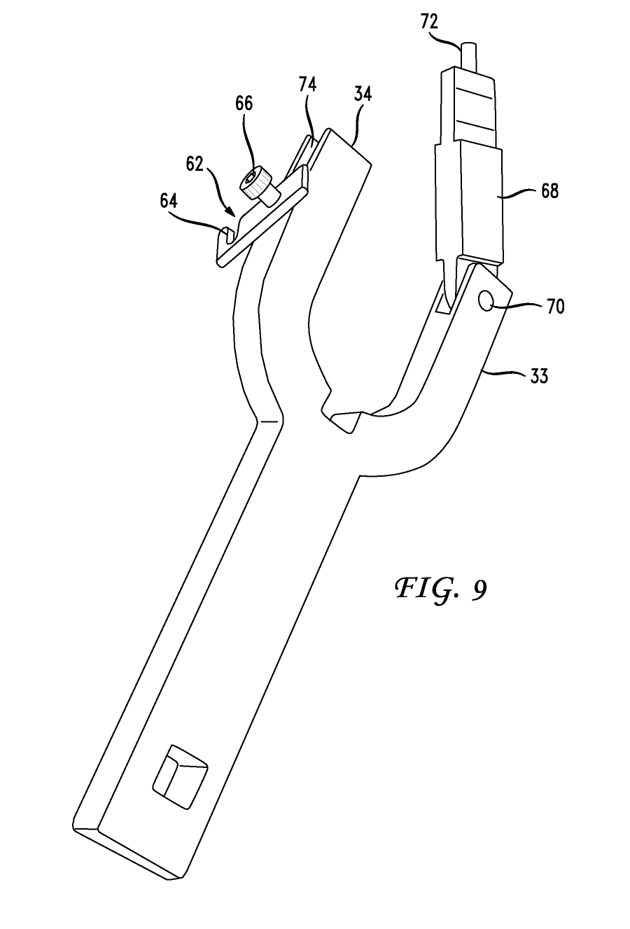

FIGS. 8 and 9 depict the torque adapter 50 having a safety mechanism 60. As shown in FIG. 9, the safety mechanism 60 comprises a retainer 62 and lock mechanism 68. The retainer 62 has a channel 64 located at one end. The attachment 66 permits the retainer 62 to swivel between an open position and the closed position. The lock mechanism 68 has bar 72 is attach to the jaw 33 and from attachment 70 can pivot between an open and closed position. To engage the safety mechanism 60, one first moves the lock mechanism into closed position where the bar 72 fits in the channel 74 of jaw 32. Then, one moves the retainer 62 from its open position to its closed position where channel 64 engages bar 72.

While preferred embodiments have been shown and described in accordance to the present invention, it should be clear to those skilled in the art that further embodiments may be made without departing from the scope and spirit of the claims.

What is claimed is:

1. A torque wrench adapter, comprising:
a yoke;
an extension; and
wherein the adapter has a length that is one-half the length of the effective torque wrench length of the torque wrench that could be attached to said adapter.

2. The torque wrench adapter of claim 1, further comprising a receiver to accept the drive of the torque wrench that could be attached to said adapter.

3. The torque wrench adapter of claim 1, further comprising a keyway dimensioned to receive the key on the input shaft of the gear reducer on the escalader that said yoke could engage.

4. The torque wrench adapter of claim 1, wherein a first exterior edge of said yoke and a second exterior edge of the extension intersect at angle θ, where θ is between 90 degrees to 170 degrees.

5. The torque wrench adapter of claim 4, where θ is between 120 degrees to 150 degrees.

6. The torque wrench adapter of claim 1, wherein the adapter's said length is 9.1875 inches.

7. The torque wrench adapter of claim 1, further comprising a safety mechanism.
